(19) United States
(12) Patent Application Publication
(10) Pub. No.: US 2025/0241272 A1
(43) Pub. Date: Jul. 31, 2025

(54) WHOLE ANIMAL FEEDER ASSISTING TOOL FOR REPTILES

(71) Applicant: Mark L. Heinrich, Carlsbad, NM (US)

(72) Inventor: Mark L. Heinrich, Carlsbad, NM (US)

(21) Appl. No.: 18/426,762

(22) Filed: Jan. 30, 2024

(51) Int. Cl. A01K 5/00

(52) U.S. Cl. CPC A01K 5/00

(57) ABSTRACT

A tool to aid in the feeding of whole animal bodies to a live reptile. The invention is designed for the use of deceased whole animal bodies, though a live animal body could be used in some instances. The tool consists of a barrel and a plunger. The barrel has an interior opening large enough to receive a whole animal body. The tip of the barrel has a beveled, angled tip which is used to assist in the opening of the reptile's mouth for feeding. The barrel may be lubricated to further assist insertion of the barrel into the reptile's mouth such as to position the animal body into the reptile esophagus. When fully depressed against the barrel, the end of the plunger will extend beyond the tip of the barrel to help push the animal body into the reptile's esophagus.

### BACKGROUND OF THE INVENTION

### 1. Field of the Invention

The present invention relates generally to a reptile feeding tool and method for use thereof, and more specifically to a tool for assisting the feeding of whole animals to live reptiles or other animals to assist in feeding.

### 2. Description of the Related Art

Caring for animals often requires manually feeding them while they are ill or otherwise unable to feed themselves. Systems designed for feeding liquid or liquified foods exist; however, what is desired is a system which can assist in the feeding of a whole animal carcass to a live reptile.

Heretofore there has not been available a system or method for a whole animal feeder assisting tool with the advantages and features of the present invention.

### BRIEF SUMMARY OF THE INVENTION

The present invention generally provides a tool to aid in the feeding of whole animal bodies to a live reptile. The preferred embodiment of the present invention is designed for the use of deceased whole animal bodies, though a live animal body could be used in some instances.

The tool consists of a barrel and a plunger. The barrel has an interior opening large enough to receive a whole animal body. The tip of the barrel has a beveled, angled tip which is used to assist in the opening of the reptile's mouth for feeding. The barrel may be lubricated to further assist insertion of the barrel into the reptile's mouth such as to position the animal body into the reptile esophagus.

The plunger is inserted into the barrel and is used to push the lubricated whole animal body into the reptile's esophagus when pressed forward through the barrel. When fully depressed against the barrel, the end of the plunger will extend beyond the tip of the barrel to help push the animal body into the reptile's esophagus.

The barrel may have a guard to help pull the plunger into the barrel.

The rear end of the plunger may have a cap which both aids in the depression of the plunger into the barrel, as well as preventing the plunger from fully entering the barrel about the rear end.

### BRIEF DESCRIPTION OF THE DRAWINGS

The drawings constitute a part of this specification and include exemplary embodiments of the present invention illustrating various objects and features thereof.

FIG. 1 is a three-dimensional isometric view of a preferred embodiment of the present invention shown in a first, staged orientation.

FIG. 2 is a detailed view thereof taken about the circle of FIG. 1.

FIG. 3 is a three-dimensional isometric view thereof shown in a second, depressed orientation.

FIG. 4 is a detailed view taken about the circle of FIG. 3.

FIG. 5 is a three-dimensional view showing the present invention in a typical environment being inserted into a live reptile's mouth, the reptile being a snake.

FIG. 6 is a side elevational view thereof showing the present invention in the first, staged orientation shown with the environment of the live reptile (e.g. a snake) and a whole animal body contained within a barrel element of the present invention.

FIG. 7 is a side elevational view thereof showing the present invention in transition from the first, staged orientation into the second, depressed orientation within the environment thereof.

FIG. 8 is a side elevational view thereof showing the present invention in a second step in transition from the first, staged orientation into the second, depressed orientation within the environment thereof.

FIG. 9 is a side elevational view thereof showing the present invention in the second, depressed orientation within the environment thereof, with the whole animal body fully inserted through the live reptile mouth.

FIG. 10 is a side elevational view thereof showing the present invention in the second, depressed orientation within the environment thereof while being withdrawn from the live reptile mouth.

FIG. 11 is a side elevational view thereof showing the present invention in the second, depressed orientation within the environment thereof with the present invention completely removed from within the live reptile mouth.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Reptile Feed Assist System 2

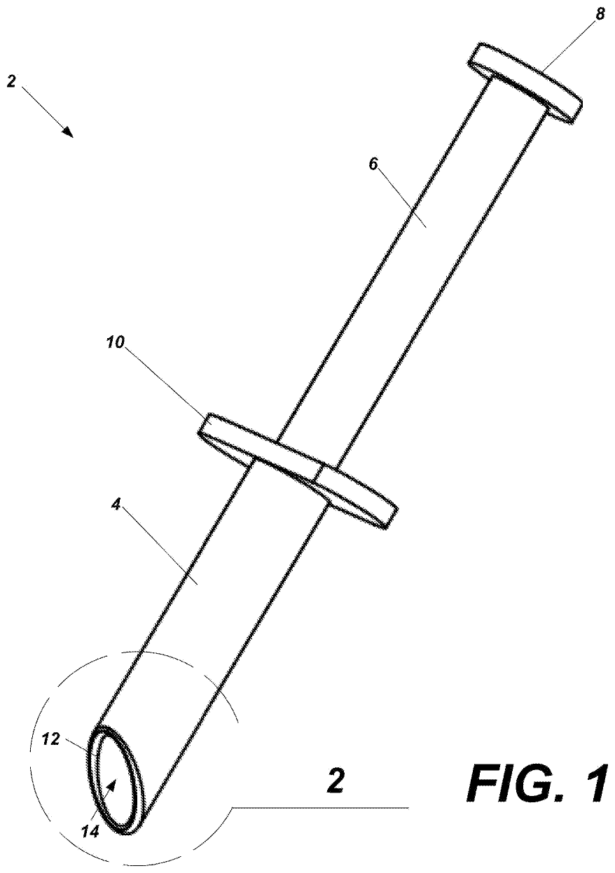

As shown in the figures, the present invention is a reptile feed assist system 2 for feeding whole animal bodies 24 to a live reptile 20 via the reptile's mouth 22. FIG. 1 shows the reptile feed assist system 2 in a first, staged orientation where it can be loaded with the whole animal body 24. As shown, the plunger 6 may have an end cap 8 which can be pressed by the user's hand and prevents the plunger 6 from fully entering the barrel 4 interior 14. The barrel 4 may have a guard 10 at its distal end which can be used to assist in manually depressing the plunger 6.

The reptile feed assist system 2 is formed from a barrel 4 and a plunger 6. The barrel forms an interior space 14 and is preferably cylindrical, but could be of any suitable shape with corresponding or otherwise suitable interior space shape. The plunger 6 has a tip 16 at its proximal end, which is inserted into the distal end of the barrel 4 and is capable of being pressed up and through the barrel 4 interior space 14.

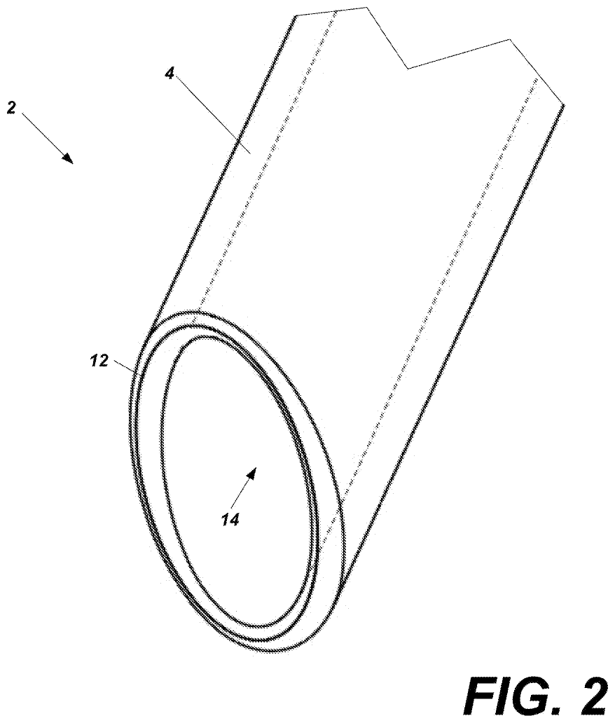

The barrel 4 has a tapered, beveled tip 12 at its proximal end. This bevel and taper makes it easier to ease open the mouth 22 of a reptile 24 being fed using the present invention. The beveled tip 12 may be lubricated to further ease the insertion of the barrel into the reptile's mouth. FIG. 2 shows this tip in more detail.

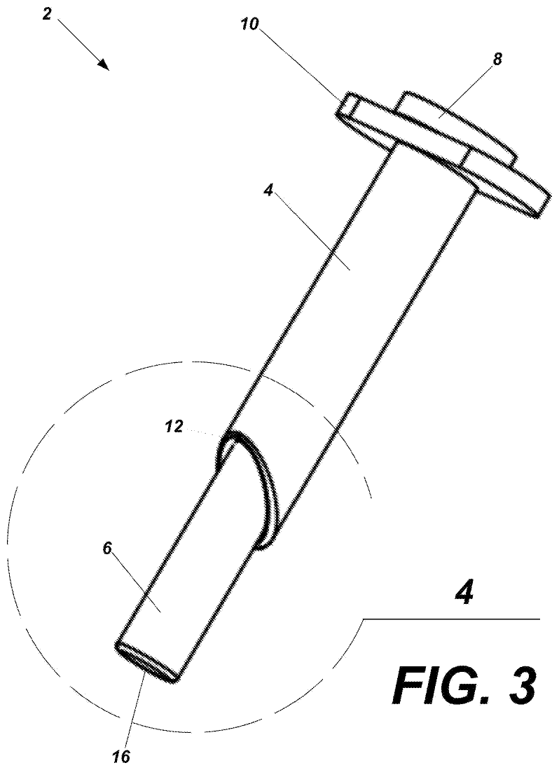

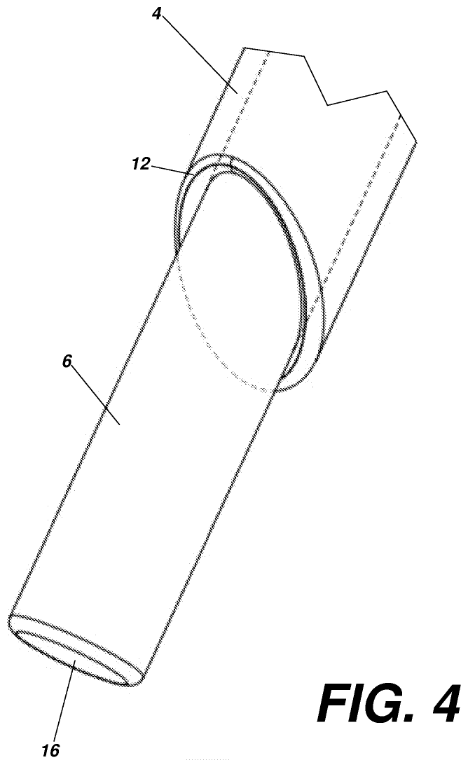

FIG. 3 shows the reptile feed assist system 2 in a second, depressed orientation where the plunger 6 is fully depressed into the barrel 4. The end cap 8 of the plunger 6 is fully in contact with the guard 10 of the barrel 4, though full depression is not necessary for function of the invention. In this orientation, the tip 16 and a portion of the plunger 6 extends out beyond the beveled tip 12 of the barrel. FIG. 4 shows this in more detail.

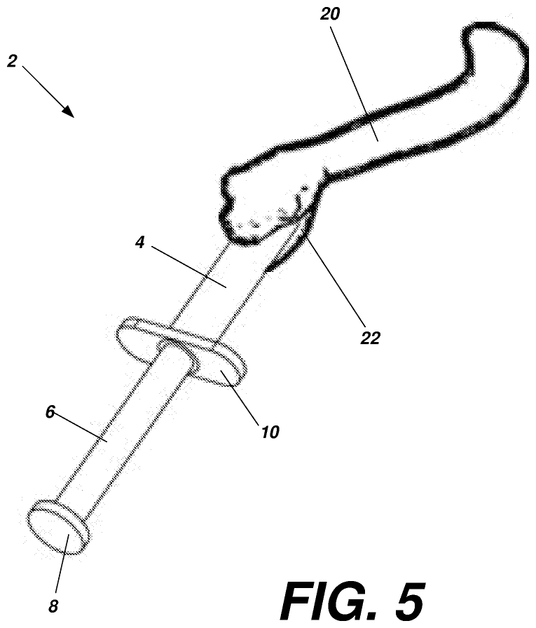

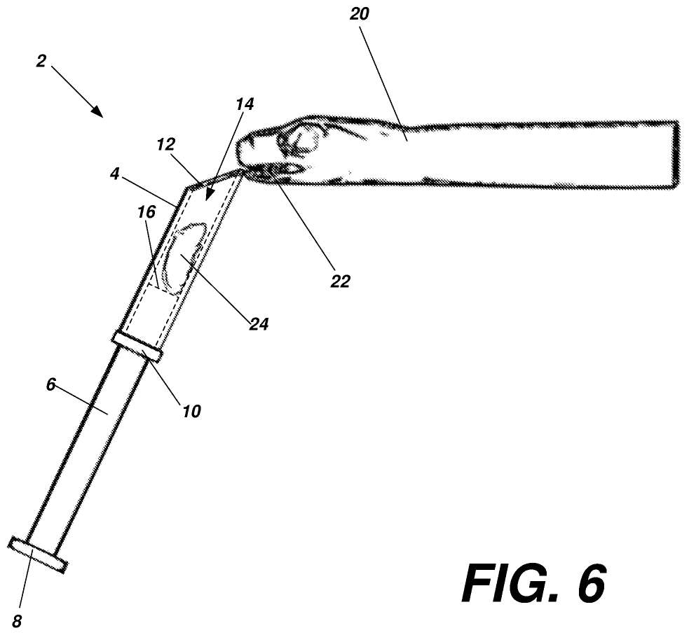

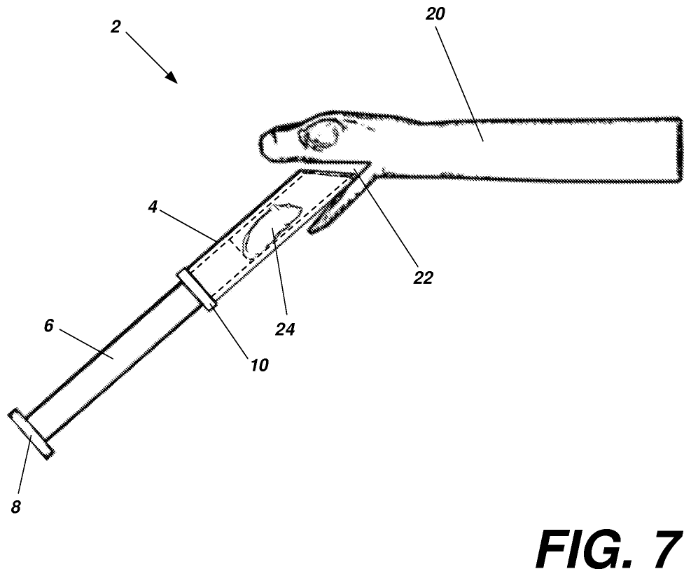

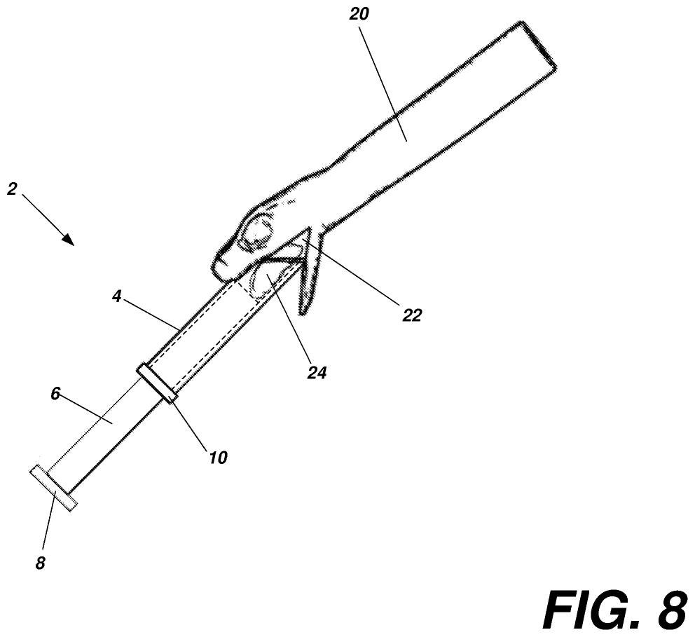

FIGS. 5-11 show, in steps, how the present invention of a reptile feed assist system 2 is used to actually feed a whole animal body 24 to a live reptile 20 via the reptile's esophagus via its mouth 22. FIG. 5 shows this in one view in the first, staged orientation. FIG. 6 shows in some detail the hidden elements within the barrel 4 interior 14, including the whole animal body 24 to be fed to the live reptile 20. The beveled tip 12 of the barrel 4 is positioned at the opening of the reptile's mouth 22. FIG. 7 shows the reptile's mouth opened by the beveled tip of the barrel 4, with the barrel being partially inserted therein. FIG. 8 continues this process, with the plunger 6 being depressed partially, thereby forcing the whole animal body 24 toward the reptile mouth 22.

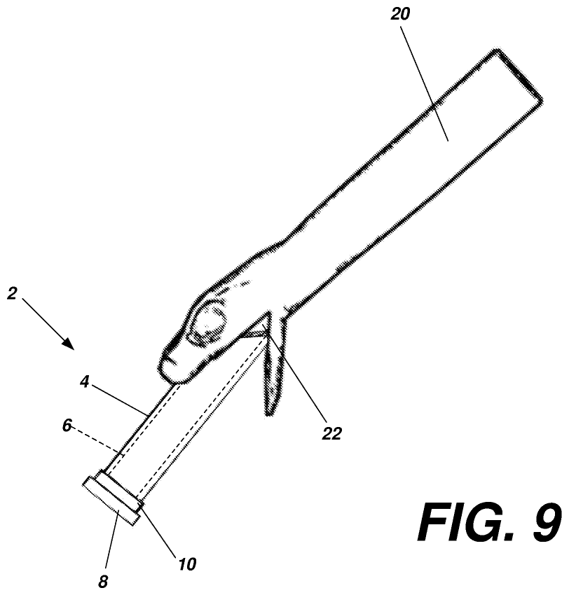

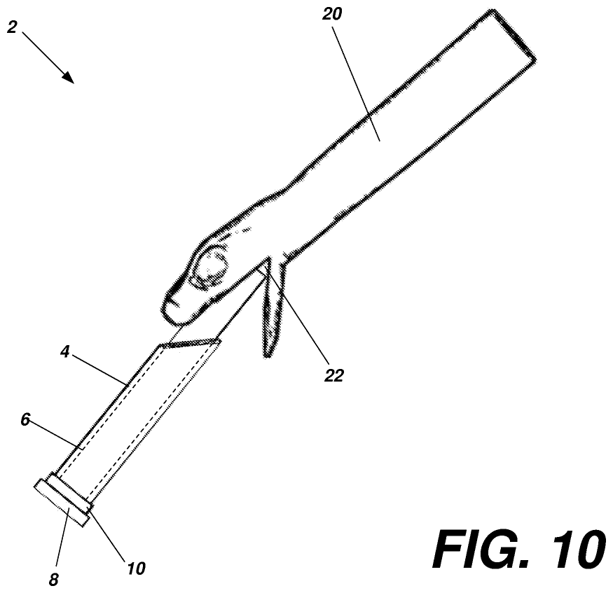

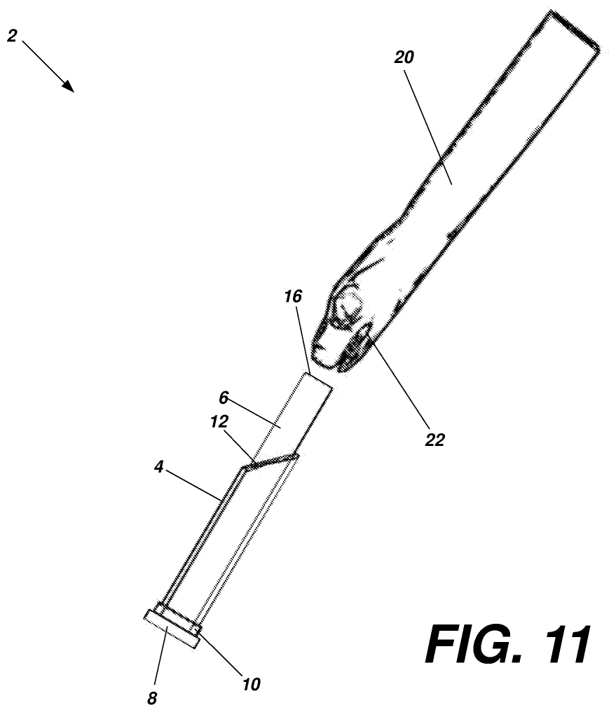

FIG. 9 shows the full depression of the plunger 6 within the barrel 4, with the whole animal body completely obscured within the reptile body. FIG. 10 shows the partial removal of the reptile feed assist system 2 and FIG. 11 shows the device fully withdrawn.

This process aids in the recovery of a reptile by assisting in feeding whole animals to the reptile, such as snakes, which is important for these reptiles to being healthy and functional.

It is to be understood that while certain embodiments and/or aspects of the invention have been shown and described, the invention is not limited thereto and encompasses various other embodiments and aspects.

1. A reptile feed assist system comprising:
a barrel comprising a proximal end and a distal end, said proximal end ending in a tapered edge comprising a beveled tip, said barrel defining an interior space and having an opening to said interior space at each of said proximal and distal ends of said barrel;
a plunger having a proximal end and a distal end, said plunger proximal end ending in a tip configured to be inserted into said distal end of said barrel and occupying said interior space of said barrel;
said barrel comprising a first length;
said plunger comprising a second length;
wherein said second length is longer than said first length, such that said plunger is configured to be transformed from a first, staged orientation whereby said tip is in proximity with said distal end of said barrel, to a second, depressed orientation whereby said tip is extended out past said tapered edge of said barrel;
said interior space of said barrel configured to receive a whole animal body configured to be fed to a live reptile;
said whole animal body comprising an animal body selected from the list comprising: a mouse; a rodent; and a rat;
wherein said tapered edge of said barrel and said beveled tip of said barrel are configured to ease the insertion of said barrel into a mouth of said live reptile; and
wherein said plunger and said barrel are configured to place said whole animal body within an esophagus of said live reptile.

2. The reptile feed assist system of claim 1, further comprising:
said distal end of said barrel comprising a guard configured to assist in manual depression of said plunger within said barrel.

3. The reptile feed assist system of claim 1, further comprising:
said distal end of said plunger comprising a cap configured to assist in manual depression of said plunger within said barrel; and
whereby said cap is further configured to prevent said plunger from being fully inserted into said barrel.

4. The reptile feed assist system of claim 1, wherein said beveled tip of said barrel is lubricated.
